(19) United States
(12) Patent Application Publication
(10) Pub. No.: US 2003/0105967 A1
(43) Pub. Date: Jun. 5, 2003

(54) Apparatus for encrypting data and method thereof

(76) Inventor: Sang Joon Nam, Kyoungki-do (KR)

Correspondence Address: MARSHALL, GERSTEIN & BORUN, Suite 6300, 233 S. Wacker Drive, Sears Tower, Chicago, IL, 60606-6357, US

(21) Appl. No.: 10/289,927

(22) Filed: Nov. 7, 2002

(30) Foreign Application Priority Data
Nov. 30, 2001 (KR) 2001-75492

(51) Int. Cl. H04L 9/32

(52) U.S. Cl. 713/189

(57) ABSTRACT

An apparatus for encrypting data between a processor and a memory and a method thereof are disclosed. The processor includes: a module for encrypting an input data or decrypting an encrypted data; a key table for storing secret keys for data encryption/decryption; and a control unit for generating an index for the encrypting operation of the module. The memory includes: a memory cell array for storing data encrypted by the module of the processor; and a key state memory for storing the index generated in the control unit of the processor and used for the encryption of the input data.

### TECHNICAL FIELD

The present disclosure relates to encryption and, more particularly, an apparatus for encrypting data between a processor and a memory and a method thereof.

### BACKGROUND

A cryptography system serves to protect an internal system from an external attack. In a current information society where smart cards have been increasingly distributed, for example, it is essential to protect personal information and bank account information of users stored in the smart cards. Because such information is stored in a predetermined memory after special operation process, the memory may be an attack objective of external attackers. Typical data encryption methods between a processor and a memory include a memory scrambling method, a bus scrambling method, and a dynamic encryption method.

In the memory scrambling method, when data is stored in a memory, a storage position of the data is changed by using an address converted by a certain algorithm instead of using an original address. Accordingly, external attackers cannot detect memory contents.

In the bus scrambling method, buses between the processor and the memory are not sequentially aligned. Although external attackers can probe the buses, they cannot decrypt bus contents.

Because the aforementioned methods are statically fixed in chip design, however, the data may be leaked by trials and errors of the attackers. To compensate for the static scrambling methods, the dynamic encryption method in U.S. Pat. No. 5,987,572 has been suggested. In particular, the dynamic encryption method employs re-encryption. While a memory access request does not exist, data is read from a memory designated by a pointer, decrypted by using the first secret key, encrypted by using the second secret key, and re-written on the memory designated by the pointer. The dynamic encryption method encrypts the data of the memory region designated by the pointer by using two different secret keys. Here, the re-encryption process performed to renew secret key information when the memory access request is not generated to merely maintain data encryption. Therefore, the re-encryption is not required in a data encrypting operation of the processor.

Further, the electronically erasable programmable read only memory (EEPROM) generally used for the smart cards has a restricted writing number. Such unnecessary re-encryption reduces the life span of the smart cards. In addition, power consumption of the whole chip is increased due to the frequent re-encryption.

### SUMMARY OF THE DISCLOSURE

An apparatus for encrypting data between a processor and a memory is disclosed. The processor includes: a module for encrypting an input data or decrypting an encrypted data; a key table for storing secret keys for data encryption/decryption; and a control unit for generating an index for the encrypting operation of the module. The memory includes: a memory cell array for storing data encrypted by the module of the processor; and a key state memory for storing the index generated in the control unit of the processor and used for the encryption of the input data.

A method for encrypting data between a processor and a memory is also disclosed. The method generally includes an encryption process and a decryption process. The encryption process includes: an index generating step for generating an encryption index; a key select step for selecting a secret key for encryption according to the index; an index storing step for storing the index used for the encryption in a special storage region of the memory; and an encrypting step for encrypting an input data by using the selected secret key. The decryption process includes: a data read step for reading an encrypted data stored in the memory; an index read step for reading the index stored in the storage region of the memory; a secret key select step for selecting a secret key for decryption according to the index; and a decrypting step for decrypting the encrypted data by using the selected secret key.

### BRIEF DESCRIPTION OF THE DRAWINGS

The above and other features of the disclosed apparatus and method will become apparent from the following description of the preferred embodiments given in conjunction with the accompanying drawings, in wherein:

FIG. 1 is a block diagram illustrating an apparatus for encrypting data between a processor and a memory;

FIG. 2 is a diagram illustrating a data encryption process between the processor and the memory;

FIG. 3 is a diagram illustrating a data decryption process between the processor and the memory;

FIG. 4 is a flowchart showing a method for encrypting data between the processor and the memory; and

FIG. 5 is a flowchart showing a method for decrypting data between the processor and the memory.

### DETAILED DESCRIPTION

An apparatus for encrypting data between a processor and a memory, and a method thereof will be described in detail with reference to the accompanying drawings.

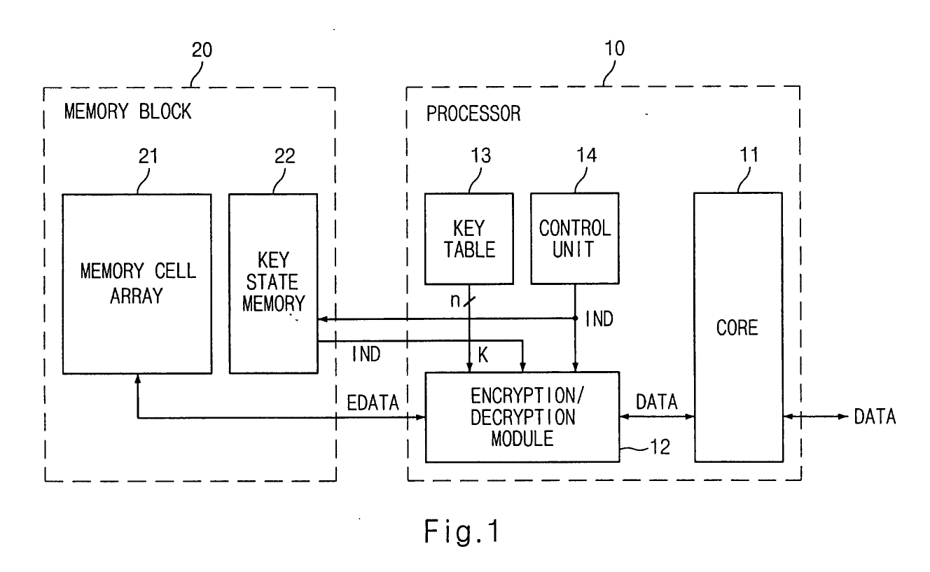

FIG. 1 is a block diagram illustrating an apparatus for dynamically encrypting data between a processor and a memory.

Referring to FIG. 1, the apparatus for encrypting data includes a processor 10 and a memory block 20. The processor 10 includes: a core 11 for storing an externally-inputted data DATA; an encryption/decryption module 12 for encrypting the data DATA stored in the core 11; a key table 13 for storing secret keys K1-Kn for data encryption/decryption; and a data encryption control unit 14 for generating an index IND for selecting the secret key Ki for the data encryption/decryption. The memory block 20 includes: a memory cell array 21 for storing data EDATA encrypted in the processor 10; and a key state memory 22 for storing the index IND used for the data encryption. Here, the index IND which is dynamic data encryption information is stored in the key state memory 22 of the memory block 20. That is, the index IND indicates which one of n secret keys K1-Kn used for the data encryption is recorded on the key state memory 22 in writing the data. In addition, the index END stored in the key state memory 22 is read with the encrypted data EDATA, and used for the data decryption. The key state memory 22 is constructed by adding a 2^{N}-bit cell to every minimum access unit (generally byte) of the memory. A memory cell of the key state memory 22 has the same configuration as the general one. The key table 13 includes a register or a memory cell for storing n secret keys K1-Kn.

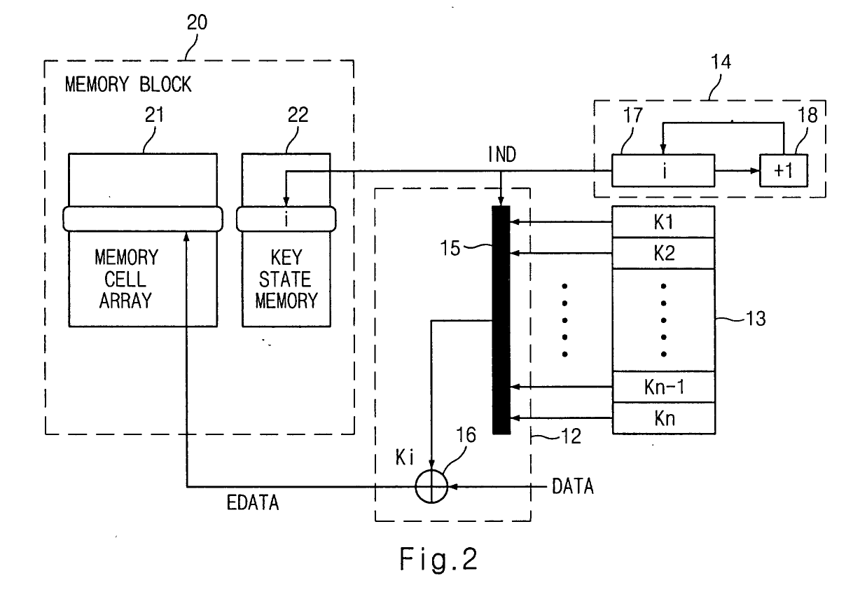

FIG. 2 is a diagram illustrating a data encryption process in the data write operation by using the apparatus for encrypting the data of FIG. 1.

According to either the index IND outputted from the data encryption control unit 14 of the processor 10 in the encryption or the index IND outputted from the key state memory 22 of the memory block 20 in the decryption, one secret key Ki or Km is selected through an N-to-1 multiplexer 15 among the n secret keys K1-Kn, and used for the encryption or decryption.

It is presumed that ‘n’ is a freely settable number set up according to specifications of the system, and the n secret keys K1-Kn were previously generated through a random number generator (not shown). The data encryption control unit 14 determines the index IND of the secret key performing the actual encryption among the secret keys stored in the key table 13. Here, the data encryption control unit 14 includes a 2^{N}-bit register 17 for storing a global index and a 2^{N}-bit incrementer 18.

In another embodiment, the data encryption control unit 14 may include a 2^{N}-bit random number generator to generate the index IND. A value stored in the bit register 17 is used as the encryption index IND in the memory write operation, increased in the incrementer 18 by +1 during a succeeding memory write operation, and stored in the bit register 17. According to the post-increment operation, even the data stored in the same address can be dynamically encrypted by using different secret keys in each memory write operation point.

The index IND used for the encryption is stored in the key state memory 22 of the memory block 20 so as to equalize the secret key for the encryption to the secret key for the decryption. The encryption/decryption module 12 encrypts the data DATA of the processor 10 or decrypts the data EDATA stored in the memory by using the secret key selected from the key table 13. Accordingly, a different secret key is selected in every encryption by the index IND of the data encryption control unit 14, to perform the dynamic data encryption.

An encryption/decryption unit 16 encrypts/decrypts the data and the secret key according to an XOR logic operation. Because the XOR logic operation is a symmetric operation for decrypting the encrypted data EDATA by the secret key used for the encryption, the original data is precisely restored.

In the data write operation, the encryption index IND is generated in the data encryption control unit 14. Here, the encryption index IND is increased by the incrementer 18 to have a different value in every memory write operation, and stored in the bit register 17. According to the index IND from the data encryption control unit 14, the multiplexer 15 selects the secret key Ki for the encryption among the plurality of secret keys K1-Kn outputted from the key table 13. The encryption/decryption unit 16 having an XOR gate encrypts the data DATA stored in the core 11 by using the selected secret key Ki. The encrypted data EDATA is written on the memory cell array 21 of the memory block 20. Here, the index IND used for the encryption is also stored in the key state memory 22 of the memory block 20.

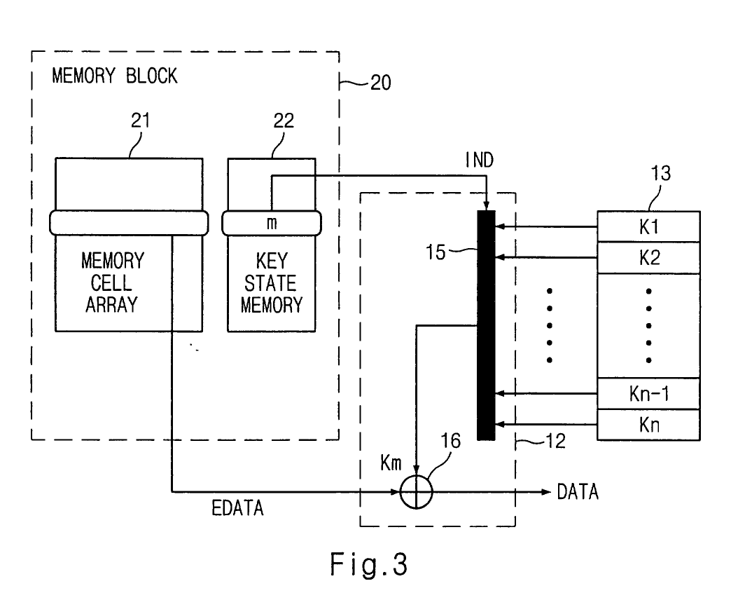

FIG. 3 is a diagram illustrating a data decryption process in the data read operation by using the apparatus for encrypting the data of FIG. 1.

As depicted in FIG. 3, in the data read operation, the encrypted data EDATA stored in the memory cell array 21 of the memory block 20 is first read with the index IND stored in the key state memory 22 of the memory block 20. According to the index IND read from the key state memory 22 of the memory block 20, the multiplexer 15 selects the same secret key Km as the one used for the encrypted data EDATA from the key table 13. Because the identical index END is used to select the secret key for the encryption and decryption, the identical key is used to encrypt/decrypt one data. As a result, the encrypted data EDATA is precisely restored to the original data DATA through the decryption process.

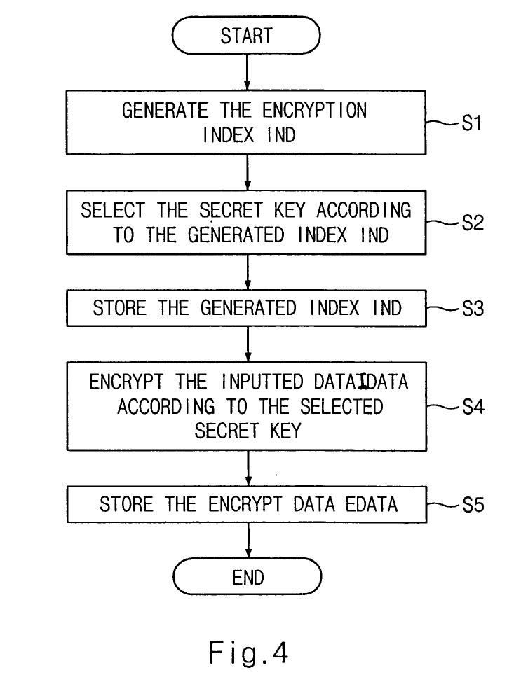

FIG. 4 is a flowchart showing a method for dynamically encrypting data between the processor and the memory.

The data encryption control unit 14 generates the encryption index IND (S1). Then the data encryption control unit 14 generates and stores an index IND′ for the next use. According to the index ND generated in the data encryption control unit 14, the multiplexer 15 selects the secret key Ki among the plurality of secret keys K1-Kn stored in the key table 13 (S2). The index IND used for the encryption is stored in the key state memory 22 of the memory block 20 (S3). The inputted data IDATA is encrypted by using the selected secret key Ki (S4). The encrypted data EDATA is stored in the memory cell array 21 of the memory block 20 (S5).

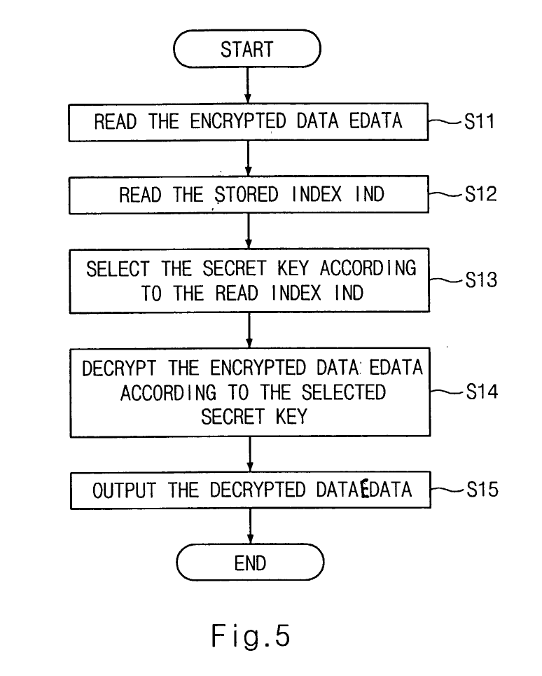

FIG. 5 is a flowchart showing a method for dynamically decrypting data between the processor and the memory.

The encrypted data EDATA stored in the memory cell array 21 of the memory block 20 is read (S11). Here, the index IND stored in the key state memory 22 of the memory block 20 is also read (S12). According to the index IND, the multiplexer 15 selects the secret key Km for the decryption among the plurality of secret keys K1-Kn (S13). The encrypted data EDATA is decrypted by using the selected secret key Km (S14), and the decrypted data is outputted (S15).

Thus, the apparatus for encrypting the data between the processor and the memory, and the method thereof disclosed herein may prevent unnecessary memory writing due to the re-encryption. Further, the apparatus and the method disclosed herein may reduce consumption power by recording the index indicating which of the plurality of secret keys is used for the data encryption on the key state memory (i.e., the special memory region in writing the data), and by reading the index stored in the key state memory in reading the data and using the index for the decryption.

Many changes and modifications to the embodiments described herein could be made. The scope of some changes is discussed above. The scope of others will become apparent from the appended claims.

What is claimed is:

1. An apparatus for encrypting data, the apparatus comprising:
a processor, the processor comprising:
a module configured to encrypt an input data or to decrypt an encrypted data;
a key table configured to store secret keys for data encryption/decryption; and
a control unit configured to generate an index for the encrypting operation of the module; and
a memory operatively coupled to the processor, the memory comprising:
a memory cell array configured to store a data encrypted by the module of the processor; and
a key state memory configured to store the index generated in the control unit of the processor and used for the encryption of the input data.

2. The apparatus according to claim 1, wherein the module comprises:
a multiplexer configured to select one of the secret keys stored in the key table; and
a logic circuit configured to encrypt an input data or decrypt an encrypted data stored in the memory according to the secret key selected by the multiplexer.

3. The apparatus according to claim 2, wherein the multiplexer selects one of the secret keys stored in the key table according to the index generated in the control unit during the encryption, and selects one of the secret keys stored in the key table according to the index stored in the key state memory of the memory during the decryption.

4. The apparatus according to claim 2, wherein the logic circuit is an XOR logic circuit.

5. The apparatus according to claim 1, wherein the control unit comprises:
a register configured to store a global index; and
an incrementing unit configured to increment a value of the index used for the encryption, and to store the value in the register.

6. The apparatus according to claim 1, wherein the control unit comprises a random number generator configured to generate the index.,

7. The apparatus according to claim 1, wherein the key state memory comprises memory cells identical to memory cells of the memory cell array.

8. A method for data encryption and decryption comprising:
generating an index;
selecting a secret key for encryption according to the index;
storing the index used for the encryption in a special storage region of a memory;
encrypting input data by using the selected secret key;
reading encrypted data stored in the memory;
reading the index stored in the storage region of the memory;
selecting a secret key for decryption according to the index; and
decrypting the encrypted data by using the selected secret key.

9. The method according to claim 8, wherein the step of generating an index comprises:
storing a global index; and
incrementing a value of the global index to be used for a successive encryption.

10. The method according to claim 8, wherein the step of generating an index comprises randomly generating the index by a random number generating unit.
